(19) United States
(12) Patent Application Publication
(10) Pub. No.: US 2026/0086016 A1
(43) Pub. Date: Mar. 26, 2026

(54) METHOD AND APPARATUS FOR MONITORING IMPURITY CONTENT TO IMPROVE MATERIAL PRODUCTION EFFICIENCY

(71) Applicant: FlowVIEW Tek, Taipei City (TW)

(72) Inventors: Yu Kai Lin, Taipei City (TW); Hsin-Yun Tsai, Taipei City (TW)

(73) Assignee: FlowVIEW Tek, Taipei City (TW)

(21) Appl. No.: 19/336,403

(22) Filed: Sep. 22, 2025

Related U.S. Application Data
(63) Continuation-in-part of application No. 19/243,624, filed on Jun. 19, 2025.
(60) Provisional application No. 63/699,176, filed on Sep. 26, 2024.

(30) Foreign Application Priority Data
Jul. 25, 2025 (TW) 114128241

(51) Int. Cl. G01N 15/075; G01N 1/38

(52) U.S. Cl. CPC G01N 15/075; G01N 1/38

(57) ABSTRACT

A method for monitoring impurity content to improve material production efficiency includes: removing adsorbent impurities and oxides on a surface of a metal block; dissolving the metal block with a mixed solution of nitric acid and hydrochloric acid but not dissolving impurities in the metal block to produce a test liquid; passing the test liquid through a transparent flow channel; recording a particle image of the impurities in the test liquid in the transparent flow channel with an optical system; and analyzing the particle image by image recognition to calculate a concentration of impurities contained per unit mass of the metal block. An apparatus for monitoring impurity content to improve material production efficiency is also provided.

### CROSS-REFERENCE TO RELATED APPLICATION

This application is a continuation-in-part application of and claims the priority benefit of U.S. application serial no. 19/243,624, filed on June 19, 2025, which claims the priority benefit of U.S. application serial no. 63/699,176, filed on September 26, 2024. This application also claims the priority benefit of Taiwan application serial no. 114128241, filed on July 25, 2025. The entirety of each of the above-mentioned patent applications is hereby incorporated by reference herein and made a part of this specification.

### BACKGROUND

### Technical Field

The disclosure relates to a measurement method and apparatus, and more particularly to a method and an apparatus for monitoring impurity content to improve material production efficiency.

### Description of the Related Art

In semiconductor manufacturing, chemical vapor deposition (CVD) and physical vapor deposition (PVD) are two common types of processes. In physical vapor deposition, a metal block material is a common raw material in a physical vapor deposition process. If the metal block material contains impurities, the impurities will be doped into a semiconductor element along with the physical vapor deposition process, thereby reducing the yield of the semiconductor element.

Currently, there is no effective way to detect the purity of the metal block raw material, and the establishment of a control line cannot be completed before manufacturing.

### SUMMARY

The disclosure provides a method for monitoring impurity content to improve material production efficiency, which can effectively measure an impurity content of a metal material.

The disclosure provides an apparatus for monitoring impurity content to improve material production efficiency, which can effectively measure an impurity content of a metal material.

An embodiment of the disclosure provides a method for monitoring impurity content to improve material production efficiency, including: removing adsorbent impurities and oxides on a surface of a metal block; dissolving the metal block with a mixed solution of nitric acid and hydrochloric acid but not dissolving impurities in the metal block to produce a test liquid; passing the test liquid through a transparent flow channel; recording a particle image of the impurities in the test liquid in the transparent flow channel with an optical system; analyzing the particle image by image recognition to calculate a concentration of impurities contained per unit mass of the metal block.

An embodiment of the disclosure provides an apparatus for monitoring impurity content to improve material production efficiency, including a transparent flow channel, an optical system, and a processor. The transparent flow channel is configured to allow a test liquid to pass through. The test liquid is produced by dissolving a metal block with a mixed solution of nitric acid and hydrochloric acid but not dissolving impurities in the metal block. The optical system is configured to record a particle image of the impurities in the test liquid in the transparent flow channel. The processor is configured to analyze the particle image by image recognition to calculate a concentration of impurities contained per unit mass of the metal block.

In the method and the apparatus for monitoring impurity content to improve material production efficiency according to the embodiments of the disclosure, the metal block is dissolved with the mixed solution of nitric acid and hydrochloric acid, but the impurities in the metal block are not dissolved to produce the test liquid, and the particle image is analyzed by image recognition to calculate the concentration of impurities contained per unit mass of the metal block. Therefore, the method and the apparatus for monitoring impurity content to improve material production efficiency according to the embodiments of the disclosure can effectively measure an impurity content of a metal material.

### BRIEF DESCRIPTION OF THE DRAWINGS

FIG. 1 to FIG. 3 are cross-sectional schematic views of a process of a method for monitoring impurity content to improve material production efficiency according to an embodiment of the disclosure.

### DESCRIPTION OF THE EMBODIMENTS

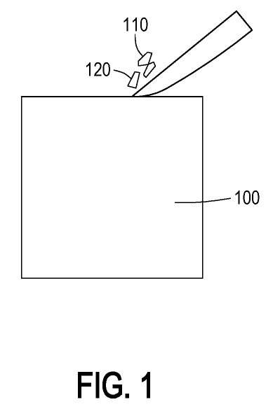

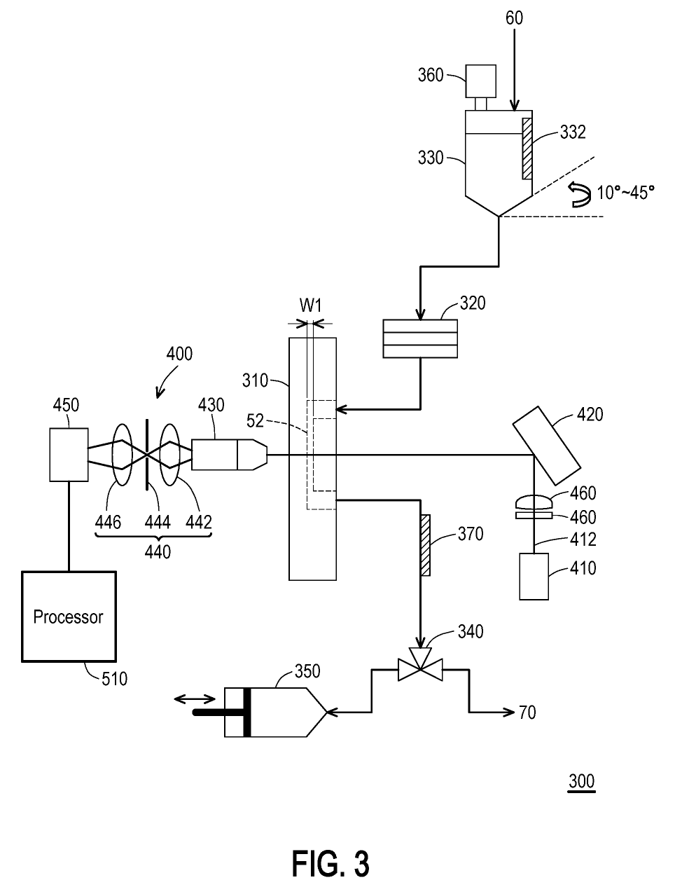

FIG. 1 to FIG. 3 are cross-sectional schematic views of a process of a method for monitoring impurity content to improve material production efficiency according to an embodiment of the disclosure, and FIG. 3 is also a cross-sectional schematic view of an apparatus for monitoring impurity content to improve material production efficiency according to an embodiment of the disclosure. Please refer to FIG. 1 to FIG. 3. The method for monitoring impurity content to improve material production efficiency of the embodiment includes the following steps. First, as shown in FIG. 1, adsorbent impurities 110 and oxides 120 on a surface of a metal block 100 are removed to prevent the adsorbent impurities 110 and the oxides 120 from affecting the subsequent dissolution experiment of the metal block 100. In the embodiment, the method for removing the adsorbent impurities 110 and the oxides 120 on the surface of the metal block 100 includes a physical method or a chemical method. In the embodiment, the surface of the metal block 100 may be removed by dissolving and then shaken dry without using an additional chemical for cleaning. In this way, impurities produced by the surface due to contact with the outside world (for example, oxidation of air and water or condensation of organic matter on the surface) may be removed. In addition, such a method may reduce the number of experimental steps and simplify the process to reduce the possibility of introducing contamination sources.

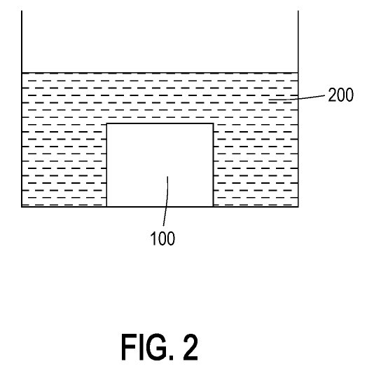

Next, as shown in FIG. 2, the metal block 100 is dissolved with a mixed solution 200 of nitric acid and hydrochloric acid, but impurities in the metal block 100 are not dissolved to produce a test liquid 60 (as shown in FIG. 3). In the embodiment, the molar ratio of nitric acid to hydrochloric acid in the mixed solution 200 falls within a range of 1 to 4. In addition, in the embodiment, the method for monitoring impurity content to improve material production efficiency may optionally include diluting an aqueous solution obtained after dissolving the metal block 100 with the mixed solution 200 with water to form the test liquid 60 with N times the volume, where N is greater than 1 and less than or equal to 4. Alternatively, in another embodiment, the aqueous solution obtained after dissolving the metal block 100 with the mixed solution 200 may be used directly as the test liquid 60 without being diluted. In the embodiment, the mixed solution 200 is sufficient to dissolve most of the metal block 100 and retain the particulate impurity morphology, so as to facilitate the observation of particle-type micro-contamination by image-based detection. In addition, compared with the aqua regia formula, reverse aqua regia (that is, the molar number of nitric acid is greater than the molar number of hydrochloric acid) is milder and less corrosive to instruments, reducing the contamination that may be caused by instrument erosion. Furthermore, diluting the aqueous solution with water can effectively prevent a large amount of salts from precipitating and making liquid detection impossible.

Then, as shown in FIG. 3, the test liquid 60 is passed through a transparent flow channel 52. In the embodiment, the test liquid 60 is filled into a sample container 330 and may be quickly filled (that is, the transparent flow channel 52 is filled) at a flow rate of 1 ml/min to 10 ml/min to prevent bubbles from being produced. Then, the flow rate of the test liquid 60 passing through the transparent flow channel 52 is maintained within a range of 0.1 ml/min to 5 ml/min to ensure that the impurities flow in a stable flow field. Furthermore, in the embodiment, a width W1 of the transparent flow channel 52 is within a range of 10 μm to 200 μm or within a range of 200 μm to 800 μm.

Then, a particle image of the impurities in the test liquid 60 in the transparent flow channel 52 is recorded with an optical system 400. In the embodiment, the optical system 400 may search for an optimal focus position within a distance of 9 μm to 180 μm or within a distance of 180 μm to 720 μm within the range of the width W1 of the transparent flow channel 52. In other words, when the width W1 is 10 μm to 200 μm or 200 μm to 800 μm, the optimal focus position is searched within a distance range of 90% of the width W1.

Afterwards, the particle image is analyzed by image recognition to calculate a concentration of impurities contained per unit mass of the metal block 100. In the embodiment, this step may be completed by a processor 510. Furthermore, in the embodiment, the step of analyzing the particle image by image recognition includes analyzing contours of particles of the impurities by an image recognition algorithm to achieve feature classification and prevent repeated counting of the particles adhering to the transparent flow channel.

In the embodiment, the method for monitoring impurity content to improve material production efficiency may further include replacing a new transparent flow channel 52 to prepare for the next detection.

An apparatus for monitoring impurity content to improve material production efficiency 300 of the embodiment includes the transparent flow channel 52, the optical system 400, and the processor 510. The transparent flow channel 52 is configured to allow the test liquid 60 to pass through, wherein the test liquid 60 is produced by the mixed solution 200 of nitric acid and hydrochloric acid dissolving the metal block 100 but not dissolving the impurities in the metal block 100. The optical system 400 is configured to record the particle image of the impurities in the test liquid 60 in the transparent flow channel 52. The processor 510 is configured to analyze the particle image by image recognition to calculate the concentration of impurities contained per unit mass of the metal block 100.

In the embodiment, the optical system 400 includes a light source 410, a spatial light modulator 420, an objective lens 430, a spatial filter 440, and an array optical sensor 450. The light source 410 is configured to emit a beam 412. The spatial light modulator 420 is disposed in a path of the beam 412 and is configured to modulate the beam 412. In the embodiment, the light source 410 is, for example, a super luminescent diode (SLD), which may prevent interference from laser speckles. In the embodiment, the spatial light modulator 420 is, for example, a reflective spatial light modulator, which may be arranged at an angle of 45 degrees with the incident beam 412 to control phase, polarization, and intensity. In the embodiment, the spatial light modulator 420 is, for example, a liquid-crystal-on-silicon (LCOS) panel or a digital micro-mirror device (DMD). Furthermore, in the embodiment, at least one achromatic collimator 460 may be disposed on the path of the beam 412 between the light source 410 and the spatial light modulator 420 to ensure the intensity of the beam 412, so as to enhance the signal strength.

The transparent flow channel 52 is located on the path of the beam 412 modulated by the spatial light modulator 420. The transparent flow channel 52 is configured as an observation platform for the particles of the impurities, wherein sheath flow is used to limit the sample from approaching the flow channel surface. In the embodiment, the transparent flow channel 52 is a replaceable transparent flow channel, which may facilitate multiple measurements.

The objective lens 430 is disposed in the path of the beam 412 from the transparent flow channel 52. In the embodiment, the objective lens 430 is, for example, an infinity-corrected objective lens, which serves as an imaging lens to modulate the light wavefront of the beam 412. The spatial filter 440 is disposed on the path of the beam 412 from the objective lens 430 and is configured to filter out high-order diffraction to improve the signal-to-noise ratio. In the embodiment, the spatial filter 440 includes a first lens element 442, a pinhole plate 444 (having a light transmitting pinhole), and a second lens element 446 sequentially disposed on the path of the beam 412. In an embodiment, the focal lengths of the first lens element 442 and the second lens element 446 are respectively, for example, 25 mm and 55 mm. The array optical sensor 450 is disposed on the path of the beam 412 from the spatial filter 440, which may significantly increase the sampling amount per instance. In the embodiment, the array optical sensor 450 is, for example, a complementary metal oxide semiconductor (CMOS) image sensor.

In the method for monitoring impurity content to improve material production efficiency and the apparatus for monitoring impurity content to improve material production efficiency 300 of the embodiments, the metal block 100 is dissolved with the mixed solution 200 of nitric acid and hydrochloric acid, but the impurities in the metal block 100 are not dissolved to produce the test liquid 60, and the particle image is analyzed by image recognition to calculate the concentration of impurities contained per unit mass of the metal block 100. Therefore, the method for monitoring impurity content to improve material production efficiency and the apparatus for monitoring impurity content to improve material production efficiency 300 of the embodiments can effectively measure an impurity content of a metal material.

In the embodiment, the apparatus for monitoring impurity content to improve material production efficiency 300 further includes a transparent flow channel apparatus 310, a particle size screening apparatus 320, the sample container 330 with a conical bottom, a three-way pipeline switching valve 340, a pump 350, and an air particle filter 360. The transparent flow channel apparatus 310 has the transparent flow channel 52. The particle size screening apparatus 320 is disposed upstream of the transparent flow channel apparatus 310. The sample container 330 is disposed upstream of the transparent flow channel apparatus 310. In the embodiment, the sample container 330 is disposed upstream of the particle size screening apparatus 320. The three-way pipeline switching valve 340 is disposed downstream of the transparent flow channel apparatus 310. The pump 350 is disposed downstream of the three-way pipeline switching valve 340 to pump fluid. The air particle filter 360 is connected to the sample container 330.

In the embodiment, the sample container 330 includes a liquid level detector 332. In addition, the apparatus for monitoring impurity content to improve material production efficiency 300 further includes a liquid filling detector 370 disposed downstream of the transparent flow channel apparatus 310. The test liquid 60 may sequentially flow through a liquid inlet of the sample container 330, the sample container 330, the particle size screening apparatus 320, the transparent flow channel apparatus 310, and the liquid filling detector 370. In the embodiment, the bottom of the sample container 330 is conical to ensure that precipitated particles in the sample may also be detected. In an embodiment, the conical bottom has an inclination angle of 10 degrees to 45 degrees relative to the horizontal plane, as shown in FIG. 3, but the disclosure is not limited thereto. The liquid filling detector 370 may ensure that the transparent flow channel 52 (for example, a micro flow channel) is filled with the test liquid 60 without being affected by air bubbles.

Furthermore, when the array optical sensor 450 detects an image of the transparent flow channel 52, the pump 350 extracts the test liquid 60 from the liquid filling detector 370, and the three-way pipeline switching valve 340 is configured to prevent the test liquid 60 from flowing out of a liquid outlet 70. After the array optical sensor 450 detects the image of the transparent flow channel 52, the pump 350 discharges the test liquid 60 from the liquid outlet 70, and the three-way pipeline switching valve 340 is configured to prevent the sample from flowing upward until the liquid filling detector 370.

In an embodiment, the processor 510 is, for example, a central processing unit (CPU), a microprocessor, a digital signal processor (DSP), a programmable controller, a programmable logic device (PLD), other similar apparatuses, or a combination of the apparatuses, and the disclosure is not limited thereto. Furthermore, in an embodiment, each function of the processor 510 may be implemented as multiple program codes. The program codes are stored in a memory and executed by the processor 510. Alternatively, in an embodiment, each function of the processor 510 may be implemented as one or more circuits. The disclosure does not limit the implementation of each function of the processor 510 by software or hardware.

In summary, in the method and the apparatus for monitoring impurity content to improve material production efficiency according to the embodiments of the disclosure, the metal block is dissolved with the mixed solution of nitric acid and hydrochloric acid, but the impurities in the metal block are not dissolved to produce the test liquid, and the particle image is analyzed by image recognition to calculate the concentration of impurities contained per unit mass of the metal block. Therefore, the method and the apparatus for monitoring impurity content to improve material production efficiency according to the embodiments of the disclosure can effectively measure the impurity content of the metal material.

What is claimed is:

1. A method for monitoring impurity content to improve material production efficiency, comprising:
remove adsorbent impurities and oxides on a surface of a metal block;
dissolving the metal block with a mixed solution of nitric acid and hydrochloric acid but not dissolving impurities in the metal block to produce a test liquid;
passing the test liquid through a transparent flow channel;
recording a particle image of the impurities in the test liquid in the transparent flow channel with an optical system; and
analyzing the particle image by image recognition to calculate a concentration of impurities contained per unit mass of the metal block.

2. The method for monitoring impurity content to improve material production efficiency according to claim 1, wherein a method for removing the adsorbent impurities and the oxides on the surface of the metal block comprises a physical method or a chemical method.

3. The method for monitoring impurity content to improve material production efficiency according to claim 1, wherein a molar ratio of nitric acid to hydrochloric acid in the mixed solution falls within a range of 1 to 4.

4. The method for monitoring impurity content to improve material production efficiency according to claim 1, further comprising diluting an aqueous solution obtained by dissolving the metal block with the mixed solution with water to form the test liquid with N times a volume, where N is greater than 1 and less than or equal to 4.

5. The method for monitoring impurity content to improve material production efficiency according to claim 1, wherein a width of the transparent flow channel is within a range of 10 µm to 200 µm or within a range of 200 µm to 800 µm.

6. The method for monitoring impurity content to improve material production efficiency according to claim 1, further comprising maintaining a flow rate of the test liquid passing through the transparent flow channel within a range of 0.1 ml/min to 5 ml/min.

7. The method for monitoring impurity content to improve material production efficiency according to claim 1, further comprising searching for an optimal focus position within a distance of 9 µm to 180 µm or within a distance of 180 µm to 720 µm within a width range of the transparent flow channel with the optical system.

8. The method for monitoring impurity content to improve material production efficiency according to claim 1, wherein the step of analyzing the particle image by image recognition comprises analyzing contours of particles of the impurities by an image recognition algorithm to achieve feature classification and prevent repeated counting of the particles adhering to the transparent flow channel.

9. The method for monitoring impurity content to improve material production efficiency according to claim 1, further comprising replacing a new transparent flow channel to prepare for a next detection.

10. An apparatus for monitoring impurity content to improve material production efficiency, comprising:
a transparent flow channel, configured to allow a test liquid to pass through, wherein the test liquid is produced by dissolving a metal block with a mixed solution of nitric acid and hydrochloric acid but not dissolving impurities in the metal block;
an optical system, configured to record a particle image of the impurities in the test liquid in the transparent flow channel; and
a processor, configured to analyze the particle image by image recognition to calculate a concentration of impurities contained per unit mass of the metal block.

11. The apparatus for monitoring impurity content to improve material production efficiency according to claim 10, wherein the test liquid is obtained by diluting an aqueous solution obtained by dissolving the metal block with the mixed solution with water to N times a volume, where N is greater than 1 and less than or equal to 4.

12. The apparatus for monitoring impurity content to improve material production efficiency according to claim 10, wherein a width of the transparent flow channel is within a range of 10 µm to 200 µm or within a range of 200 µm to 800 µm.

13. The apparatus for monitoring impurity content to improve material production efficiency according to claim 10, wherein a flow rate of the test liquid passing through the transparent flow channel is maintained within a range of 0.1 ml/min to 5 ml/min.

14. The apparatus for monitoring impurity content to improve material production efficiency according to claim 10, wherein the optical system is configured to search for an optimal focus position within a distance of 9 μm to 180 μm or within a distance of 180 μm to 720 μm within a width range of the transparent flow channel.

15. The apparatus for monitoring impurity content to improve material production efficiency according to claim 10, wherein the processor is configured to analyze contours of particles of the impurities by an image recognition algorithm to achieve feature classification and prevent repeated counting of the particles adhering to the transparent flow channel.

16. The apparatus for monitoring impurity content to improve material production efficiency according to claim 10, wherein the transparent flow channel is a replaceable transparent flow channel.

17. The apparatus for monitoring impurity content to improve material production efficiency according to claim 10, wherein the optical system comprises:
a light source, configured to emit a beam;
a spatial light modulator, disposed on a path of the beam and configured to modulate the beam, wherein the transparent flow channel is located on the path of the beam modulated by the spatial light modulator;
an objective lens, disposed on the path of the beam from the transparent flow channel;
a spatial filter, disposed on the path of the beam from the objective lens; and
an array optical sensor, disposed on the path of the beam from the spatial filter.
